(19) United States
(12) Patent Application Publication
(10) Pub. No.: US 2026/0170294 A1
(43) Pub. Date: Jun. 18, 2026

(54) Instance-Level Segmentation Applied to Dynamic Graphs for Enhanced Model Explainability

(71) Applicant: Srikanth Vemula, Sartell, MN (US)

(72) Inventor: Srikanth Vemula, Sartell, MN (US)

(21) Appl. No.: 19/054,837

(22) Filed: Feb. 15, 2025

(51) Int. Cl. G06N 3/042; G06N 3/10

(52) U.S. Cl. CPC G06N 3/042; G06N 3/105

(57) ABSTRACT

This invention discloses a novel method for enhancing the explainability of graph neural networks (GNNs) applied to dynamic graphs. The method leverages instance-level segmentation to identify and segment important subgraphs or clusters of nodes that contribute significantly to the GNN's prediction. By generating explanations based on these segmented instances, the invention provides a more granular and dynamic understanding of the GNN's decision-making process. This approach offers enhanced granularity, dynamic explainability, and improved interpretability, enabling users to gain a deeper understanding of the GNN's behavior and build trust in its predictions.

### PRIOR ART

Prior art in the field can be categorized into three main areas:

### a) Dynamic Graph Analysis:

Temporal Graph Networks (TGNs): These networks incorporate temporal information into the graph structure, allowing the model to capture the evolution of node and edge features over time. However, TGNs primarily focus on improving predictive performance and do not explicitly address explainability.

Dynamic Graph Convolutional Networks (DGCNs): These networks extend traditional graph convolutional networks to handle dynamic graphs by incorporating mechanisms to account for changes in the graph structure and node features. However, DGCNs do not explicitly address the explainability of their predictions.

Recurrent Graph Neural Networks (RGNNs): These networks apply recurrent neural network architectures to process sequences of graph snapshots, capturing temporal dependencies in the graph's evolution. However, RGNNs do not explicitly address the explainability of their predictions.

### b) XAI for GNNs:

GNNExplainer: This method identifies crucial subgraphs and node features for explaining predictions. However, it is often limited to instance-level explanations and may not generalize well to unseen nodes or provide a global understanding of the model.

GraphXAI: This framework provides a systematic way to evaluate and benchmark the quality of GNN explanations. However, it primarily focuses on static graphs and does not explicitly address the challenges of explaining dynamic graphs.

Natural Language Narratives: Some approaches use natural language narratives to enhance explainability by translating technical explanations into more accessible formats. However, these narratives may not always capture the full complexity of the model's behavior in dynamic graphs.

### c) Instance-Level Segmentation:

Mask R-CNN: This is a popular instance-level segmentation method used in computer vision. However, it has not been applied to the domain of dynamic graph explainability for GNNs.

YOLACT: This is a single-stage instance-level segmentation method that offers faster processing speed. However, it has not been applied to the domain of dynamic graph explainability for GNNs.

DETR: This is a transformer-based instance-level segmentation method that excels at capturing long-range dependencies. However, it has not been applied to the domain of dynamic graph explainability for GNNs.

Despite these advancements, there remains a need for a comprehensive XAI framework that effectively addresses the challenges of explaining GNNs applied to dynamic graphs. This invention aims to bridge this gap by introducing a novel approach that leverages instance-level segmentation techniques to provide enhanced model explainability.

### BACKGROUND OF THE INVENTION

Graph neural networks (GNNs) have emerged as a powerful tool for analyzing graph-structured data, enabling various applications such as predicting customer churn in social networks, classifying the toxicity of molecules, and recommending products in e-commerce networks. However, understanding the decision-making process of GNNs, especially when applied to dynamic graphs, remains a challenge.

Dynamic graphs, which evolve over time with changing nodes and edges, introduce further complexity to model explainability. Existing XAI methods for GNNs primarily focus on static graphs, providing explanations based on node features and local graph structures. These methods often fall short in capturing the temporal dynamics and intricate relationships within evolving graphs. For example, traditional methods may struggle to explain how the addition or removal of a node in a social network influences the GNN's prediction of information flow or community formation.

While instance-level segmentation has been successfully applied in computer vision for tasks such as object detection and image segmentation, its application to dynamic graph explainability for GNNs remains unexplored. This invention addresses this gap by introducing a novel approach that leverages instance-level segmentation to provide a more granular and dynamic understanding of GNNs applied to dynamic graphs.

### SUMMARY OF THE INVENTION

This invention provides a novel method for enhancing the explainability of GNN models applied to dynamic graphs. By leveraging instance-level segmentation, the invention identifies and segments important subgraphs or clusters of nodes, generating explanations that highlight the key factors influencing the GNN's prediction at each time step. This approach offers enhanced granularity, dynamic explainability, and improved interpretability, enabling users to gain a deeper understanding of the GNN's decision-making process.

### BRIEF DESCRIPTION OF DRAWINGS

FIG. 1: Illustrates the process of instance-level segmentation applied to a dynamic graph.

FIG. 1A Shows a dynamic graph G represented as a sequence of snapshots Gₜ at different time steps (t₀, t₁, t₂). Each snapshot captures the state of the graph with its nodes and edges at a particular time step. Nodes are represented as circles, and edges are represented as lines connecting the circles.

FIG. 1B Depicts the application of instance-level segmentation to each snapshot. Different colors represent distinct instances or clusters of nodes Iᵢ identified within each snapshot. These instances are determined based on node features and their evolving relationships over time.

FIG. 1C Shows the generation of explanations Eᵢ based on the segmented instances. These explanations can be in the form of visual highlights, textual descriptions, or natural language narratives, providing insights into the GNN's prediction at each time step.

### DETAILED DESCRIPTION OF THE INVENTION

This invention proposes a new method for enhancing the explainability of GNN models applied to dynamic graphs. This method leverages instance-level segmentation, a technique commonly used in computer vision for identifying and delineating individual objects within an image. The key insight of this invention lies in adapting this technique to the domain of dynamic graph explainability, where the goal is to identify and segment influential subgraphs or clusters of nodes within a dynamic graph.

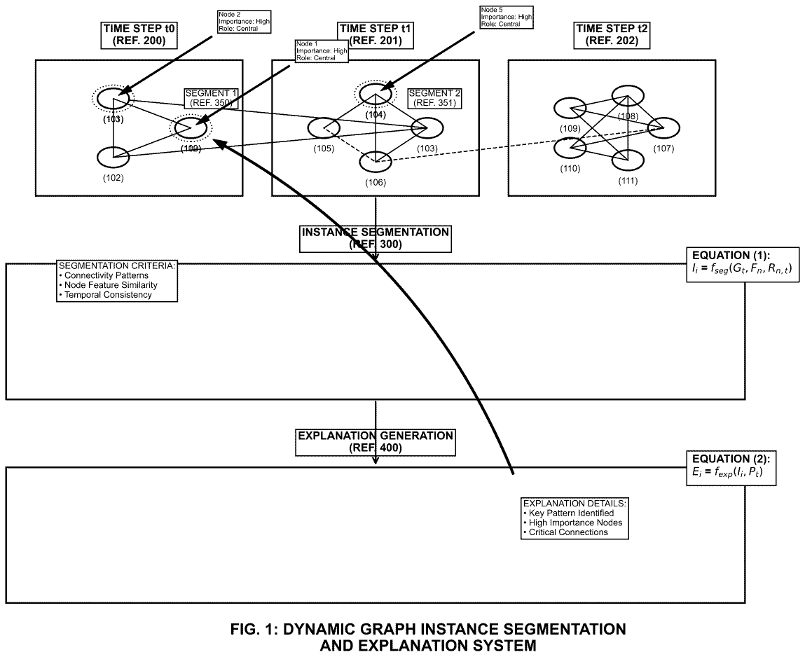

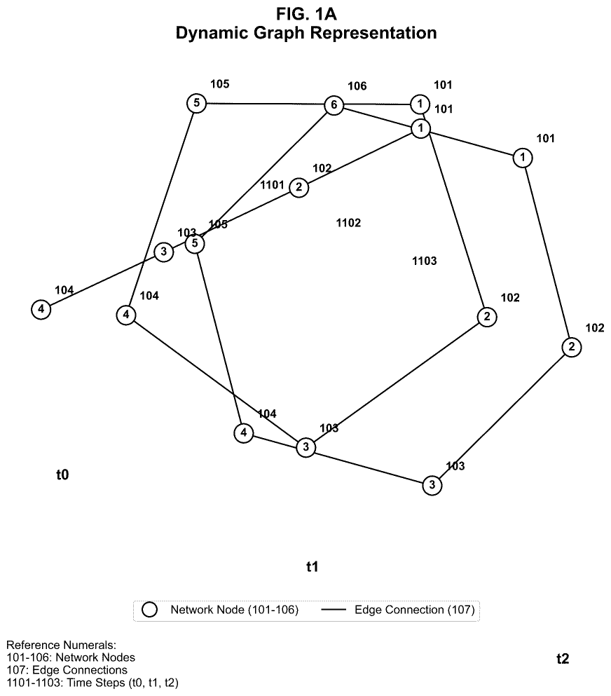

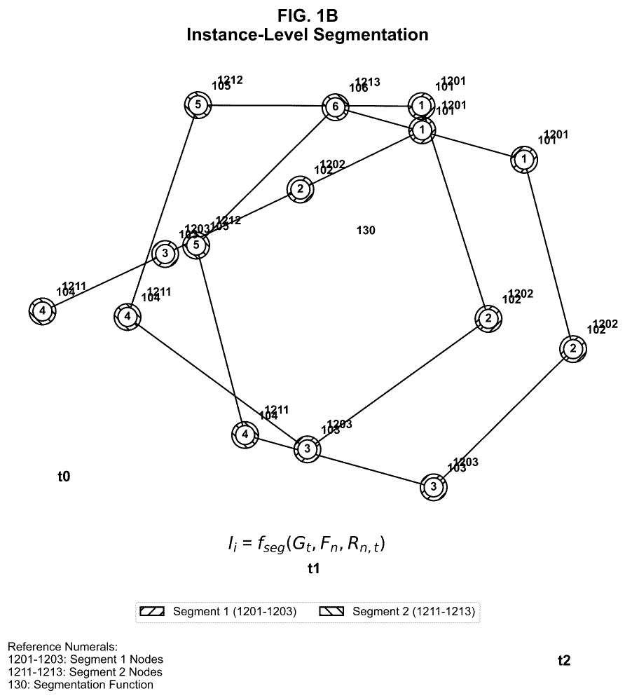

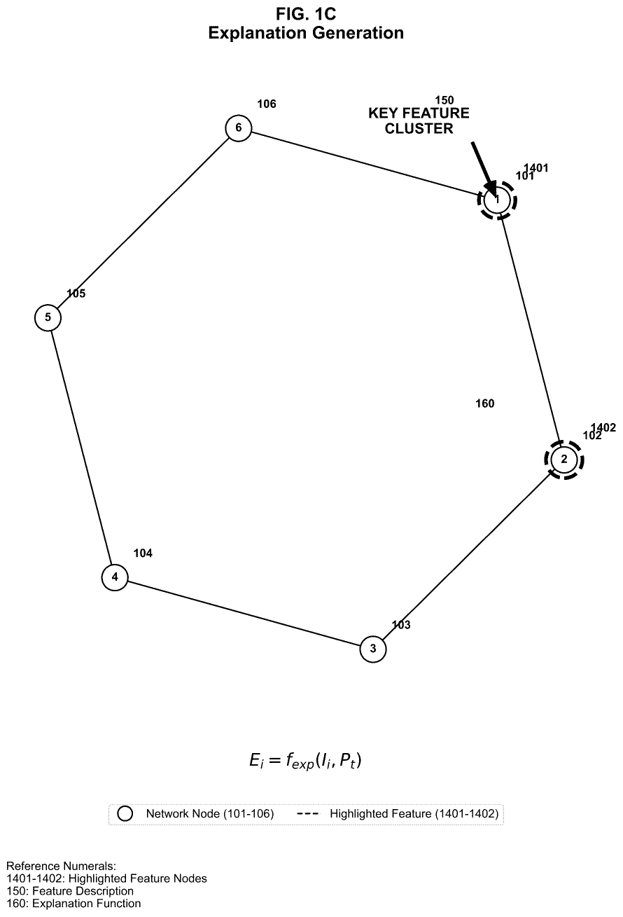

FIG. 1 depicts an exemplary embodiment of a dynamic graph instance segmentation and explanation system implementing a temporal-aware graph processing algorithm. The system comprises three primary processing stages operating on sequential time steps t₀, t₁, and t₂ (referenced as 200, 201, and 202 respectively).

### Dynamic Graph Representation (FIG. 1A):

The dynamic graph G is represented as a sequence of snapshots Gₜ, where each snapshot captures the state of the graph at a specific time step t, as shown in FIG. 1A. This representation allows the invention to capture the temporal evolution of the graph and its impact on the GNN's predictions. At each time step, the system maintains a graph state Gₜ comprising vertices {v1 . . . vn} interconnected by edges {e1 . . . em}. The temporal progression illustrates the evolution of node relationships, wherein:

Time step t₀ (200) establishes an initial graph configuration with nodes (100, 101, 102) and their associated connectivity patterns.

Time step t₁ (201) demonstrates graph evolution with nodes (103, 104, 105, 106) maintaining temporal consistency with the previous state.

Time step t₂ (202) represents the final observed state comprising nodes (107, 108, 109, 110, 111) and their evolved interconnections.

Each network node (101-106) is uniquely identified and maintains persistent connectivity patterns through edge connections (107) across temporal transitions, enabling systematic analysis of network evolution and structural dynamics. The temporal progression (1101-1103) demonstrates the system's capability to represent dynamic network growth while preserving relational integrity between existing nodes and accommodating new network elements. This representation allows the invention to capture the temporal evolution of the graph and its impact on the GNN's predictions.

### Instance-Level Segmentation (FIG. 1B):

For each snapshot of the dynamic graph Gₜ, the invention applies instance-level segmentation to identify and segment important subgraphs or clusters of nodes Iᵢ that contribute significantly to the GNN's prediction, as shown in FIG. 1B. This segmentation process considers both node features Fₙ and the evolving relationships between nodes R_{n,t} as represented in Equation 1:

$${I}_{i} = {f}_{seg} ( {G}_{t} , {F}_{n} , {R}_{n , t} ) \qquad Equation 1$$

where: Iᵢ represents the i-th instance in the graph at time step t. f_{seg} is the instance-level segmentation function. Gₜ is the graph snapshot at time step t. Fₙ represents the node features. R_{n,t} represents the relationships between nodes at time step t.

This step draws inspiration from graph-based instance segmentation methods in computer vision, where graph representations are used to propagate segmentation information across data representations. For instance, in a dynamic social network, the invention might segment a group of users who exhibit similar interaction patterns and influence the GNN's prediction of information diffusion. The algorithm identifies distinct graph segments (350, 351) based on the computed instance matrices, preserving both spatial and temporal relationships.

Furthermore, the invention can be applied to various types of dynamic graph representations, including point clouds, which are commonly used to represent 3D structures and can be analyzed using instance segmentation techniques. This allows the invention to be applied to a wide range of applications, such as analyzing dynamic protein interactions or understanding the evolution of 3D point cloud data in robotics.

### Explanation Generation (FIG. 1C):

Based on the segmented instances Iᵢ, the invention generates explanations Eᵢ that highlight the key factors influencing the GNN's prediction Pₜ at each time step t. These explanations can be presented in various formats, including:

Visual Highlights: The segmented instances can be visually highlighted on the dynamic graph, allowing users to see the influential subgraphs or clusters of nodes.

Textual Descriptions: The invention can generate textual descriptions that summarize the characteristics of the segmented instances and their contribution to the prediction.

Natural Language Narratives: The invention can leverage natural language generation techniques to create narratives that explain the GNN's reasoning process in a more accessible and engaging way.

This process is represented in Equation 2:

$${E}_{i} = {f}_{exp} ( {I}_{i} , {P}_{t} ) \qquad Equation 2$$

where: Eᵢ represents the explanation for the i-th instance, fₑₓₚ is the explanation generation function, Iᵢ is the i-th instance and Pₜ is the GNN's prediction at time step t.

The system implements an explanation function (160), defined by Equation 2, for generating interpretable descriptions of network features. A network structure comprises nodes (101-106) interconnected by edges; wherein specific nodes are identified as highlighted feature nodes (1401-1402) representing key structural elements within the network topology. A key feature cluster (150) is identified within the network, encompassing highlighted feature nodes (1401-1402) that exhibit significant topological or functional properties warranting detailed explanation. The explanation function (160) processes the identified features to generate descriptive outputs characterizing the relationships between highlighted feature nodes (1401-1402), the significance of the key feature cluster (150), and the structural properties of the identified network components. The system maintains a clear delineation between standard network nodes (101-106) and highlighted feature nodes (1401-1402), enabling focused analysis of significant network characteristics while preserving overall topological context.

### Visualization and Interaction:

The invention provides tools for visualizing the dynamic graph, the segmented instances, and the generated explanations. Users can interact with these visualizations to explore the model's behavior and gain a deeper understanding of its decision-making process. For example, users can select a specific time step to see the corresponding graph snapshot and the segmented instances, or they can hover over a segmented instance to view its textual description or natural language narrative.

### Advantages Over Existing XAI Methods:

This invention offers several advantages over existing XAI methods for GNNs:

Enhanced Granularity: By applying instance-level segmentation, the invention provides a more fine-grained understanding of the GNN's decision-making process, highlighting the specific subgraphs or clusters of nodes that contribute to the prediction. This goes beyond traditional XAI methods that focus on individual nodes or edges, providing a more comprehensive view of the model's behavior.

Dynamic Explainability: The invention captures the temporal dynamics of the graph, providing explanations that evolve over time and reflect the changing relationships between nodes. This allows users to understand how the GNN's predictions are influenced by the addition or removal of nodes and edges, as well as changes in node and edge features. This dynamic perspective is crucial for understanding GNNs applied to evolving graphs, which is not adequately addressed by existing XAI methods for static graphs.

Improved Interpretability: The invention generates explanations that are more accessible and interpretable to users, facilitating a better understanding of the GNN's behavior. This can be achieved through various formats, such as visual highlights, textual descriptions, and natural language narratives, making it easier for users to grasp the model's reasoning process. This enhanced interpretability can help build trust in the model's predictions and encourage wider adoption of GNNs in various applications.

### Implementation Algorithm

Algorithm 1: Instance-Level Segmentation for Dynamic Graph Explainability

```
  Input: Dynamic graph G = {Gₜ}, trained GNN model M
  Output: Explanations E for M's predictions on G
  1. Initialization:
  The algorithm starts with a dynamic graph G represented as a sequence of snapshots Gₜ,
where each snapshot captures the state of the graph at a specific time step t.
  A trained GNN model M is provided, which has been trained to make predictions on the
dynamic graph G.
  2. Instance-Level Segmentation:
  Iterate through Snapshots: The algorithm iterates through each snapshot Gₜ in the
dynamic graph G.
  Apply Segmentation Function: For each snapshot Gₜ, an instance-level segmentation
function f_{seg} is applied to identify influential instances {Iᵢ}. This function considers both node
features Fₙ and the evolving relationships between nodes R_{n,t} at time step t, as represented in
Equation 1:
${I}_{i} = {f}_{seg} ( {G}_{t} , {F}_{n} , {R}_{n , t} )$
  Explanation Generation: For each identified instance Iᵢ, an explanation Eᵢ is generated
using an explanation generation function fₑₓₚ. This function takes the instance Iᵢ and the GNN's
prediction Pₜ at time step t as input, as represented in Equation 2:
${E}_{i} = {f}_{exp} ( {I}_{i} , {P}_{t} )$
  3. Explanation Aggregation:
  After generating explanations for each instance in each snapshot, the algorithm
aggregates the explanations {Eᵢ} across all time steps to provide a comprehensive explanation E
for the GNN model's predictions on the entire dynamic graph G.
```

### Enhancements:

This algorithm enhances the explainability of the GNN model applied to dynamic graphs in several ways:

Enhanced Granularity: By applying instance-level segmentation, the algorithm identifies and segments influential subgraphs or clusters of nodes within each snapshot of the dynamic graph. This provides a more fine-grained understanding of the GNN's decision-making process compared to methods that only consider individual nodes or edges. This allows users to see which specific parts of the graph are most important for the GNN's prediction at each time step.

Dynamic Explainability: The algorithm captures the temporal dynamics of the graph by analyzing the segmented instances across different time steps. This allows users to understand how changes in the graph structure and node features over time affect the model's behavior. This dynamic perspective is crucial for understanding GNNs applied to evolving graphs, which is not adequately addressed by existing XAI methods for static graphs.

Improved Interpretability: The algorithm generates explanations that are more accessible and interpretable to users. This can be achieved through various formats, such as visual highlights, textual descriptions, and natural language narratives, making it easier for users to grasp the model's reasoning process. This enhanced interpretability can help build trust in the model's predictions and encourage wider adoption of GNNs in various applications.

In essence, the algorithm provides a more comprehensive and dynamic view of the GNN's decision-making process, making it easier for users to understand how the model arrives at its predictions on evolving graphs. This enhanced explainability can lead to increased trust, better debugging of models, and more informed decision-making in various applications.

1. A method for enhancing the explainability of a graph neural network (GNN) model applied to a dynamic graph, comprising:
representing the dynamic graph G as a sequence of snapshots Gₜ, each snapshot capturing the state of the graph at a specific time step t;
applying instance-level segmentation to each snapshot Gₜ of the dynamic graph to identify and segment important subgraphs or clusters of nodes Iᵢ that contribute significantly to the GNN's prediction, wherein the instance-level segmentation considers both node features Fₙ and the evolving relationships between nodes R_{n,t}, represented as:
$${I}_{i} = {f}_{seg} ( {G}_{t} , {F}_{n} , {R}_{n , t} )$$
generating explanations Eᵢ based on the segmented instances Iᵢ, highlighting the key factors influencing the GNN's prediction Pₜ at each time step t, represented as:
$${E}_{i} = {f}_{exp} ( {I}_{i} , {P}_{t} )$$
providing tools for visualizing the dynamic graph, the segmented instances, and the generated explanations.

2. The method of claim 1, wherein the explanations Eᵢ are presented in a format selected from the group consisting of:
visual highlights of the segmented instances Iᵢ on the dynamic graph;
textual descriptions summarizing the characteristics of the segmented instances and their contribution to the prediction; and
natural language narratives explaining the GNN's reasoning process.

3. The method of claim 1, wherein the tools for visualization allow users to interact with the dynamic graph, the segmented instances, and the generated explanations to explore the model's behavior.

4. A system for enhancing the explainability of a GNN model applied to a dynamic graph, comprising:
a dynamic graph representation module configured to represent the dynamic graph as a sequence of snapshots;
an instance-level segmentation module configured to apply instance-level segmentation to each snapshot to identify and segment important subgraphs or clusters of nodes;
an explanation generation module configured to generate explanations based on the segmented instances; and
A visualization and interaction module configured to provide tools for visualizing the dynamic graph, the segmented instances, and the generated explanations.

5. The system of claim 4, wherein the instance-level segmentation module considers both node features and the evolving relationships between nodes.

6. The system of claim 4, wherein the explanation generation module generates explanations in a format selected from the group consisting of visual highlights, textual descriptions, and natural language narratives.

7. The system of claim 4, wherein the visualization and interaction module allows users to interact with the dynamic graph, the segmented instances, and the generated explanations to explore the model's behavior.
